(19) United States
(12) Patent Application Publication
(10) Pub. No.: US 2005/0116542 A1
(43) Pub. Date: Jun. 2, 2005

(54) In-home dispersed power source system

(75) Inventors: Yusuke Kihara, Chiyoda-ku (JP); Akiyoshi Komura, Chiyoda-ku (JP)

Correspondence Address: CROWELL & MORING LLP;INTELLECTUAL PROPERTY GROUP, P.O. BOX 14300, WASHINGTON, DC, 20044-4300, US

(73) Assignee: Hitachi, Ltd.

(21) Appl. No.: 10/785,945

(22) Filed: Feb. 26, 2004

(30) Foreign Application Priority Data
Dec. 1, 2003 (JP) 2003-401567

(51) Int. Cl. G02F 1/1335

(52) U.S. Cl. 307/29

(57) ABSTRACT

In an in-home dispersed power source system designed to supply electric power to a plurality of home electric appliances with using a dispersed power source in combination with a commercial power source, a control means, which is connected to the dispersed power source and the plurality of the home electric appliances via a network and which control means performs ON/OFF control of each of the home electric appliances, is provided, wherein the control means makes each of the home electric appliances follow a response delay of power generation operation of the dispersed power source by selective ON/OFF control of the plurality of the home electric appliances.

### BACKGROUND OF THE INVENTION

1. Field of the Invention

The present invention relates to a dispersed power source system equipped with individual generating equipment, and particularly, to an in-home dispersed power source system suitable for a residence equipped with network electric appliances.

2. Description of the Related Art

Conventionally is known a dispersed power source system in which a cogeneration facility is installed at a residence and which system is designed so that the cogeneration facility covers a part of electric power and heat consumed at general home (see Japanese Patent Laid-Open Publication No. 2003-173808).

Here, the cogeneration facility is generating equipment that drives a generator making an internal combustion engine a motor, obtains electric power from the generator, and recovers exhaust heat of the motor, thereby utilizing it as a heat source. As the internal combustion engine, a gas engine that makes a city gas a fuel is common.

Since an introduction of the dispersed power source system can meet a hot water supply and heat demand of a cooler and a heater by exhaust heat, it is advantageous in energy saving and economical efficiency and moreover results in lessening of contract electric power that should be contracted with an electric power supplier such as a power company, thereby an electric power fare being able to be lowered.

On the other hand, a recent progress of communications technology is remarkable, and based upon this, networking of home electric appliances (electric appliances for home use) proceeds, remote control operation and central control of the home electric appliances are foreseen, and high expectations have become to be put on the energy saving by automatic operation and optimum control in response to users' needs.

Incidentally, at general home there are many home electric appliances used for a short time, for example, such as a hair dryer and a microwave, whose electric power loads are from several hundred watts to around one thousand and several hundred watts, and thereby load variations of a power source are large. Furthermore, an electric power load at such home variously varies from a large to small amount, depending on time zones.

Here, provided that when introducing the dispersed power source system into general home, it is operated in a constant load and an amount due to load variations is burdened on a commercial power source, then equipment corresponding to a maximum value of the amount due to the load variations becomes necessary for the commercial power source and an equipment investment increases, thereby the introduction of the commercial power source becoming considerably meaningless.

Consequently, although in this case it is desirable to make a maximum value of the electric power load for the commercial power source constant, a conventional dispersed power system is bad in response, for example, taking not less than several seconds before the dispersed power source is actually activated after switches of the home electric appliances are turned on, whereby there is a problem that a feeling of strangeness occurs in operation and amenities are damaged.

In addition, although at this time the dispersed power source needs to meet all load conditions from a low to high load, and therefore, it needs partial load operation, in this case a lowering of operation efficiency becomes another problem.

### SUMMARY OF THE INVENTION

The present invention is found considering the problems described above and its exemplary object is to provide an efficient in-home dispersed power source system that is designed to be able to obtain comfortable operation of home electric appliances.

The above object is achieved in an in-home dispersed power source system, which is designed to supply electric power to a plurality of the home electric appliances with using a dispersed power source in combination with a commercial power source, by a control means being provided which means is connected to the dispersed power source and the plurality of the home electric appliances via a network and which means performs ON/OFF control of each of the home electric appliances; and the control means making each of the home electric appliances follow a response delay of power generation operation of the dispersed power source by selective ON/OFF control of the plurality of the home electric appliances.

Similarly, the above object is also achieved in another in-home dispersed power source system designed to supply electric power to a plurality of the home electric appliances with using the dispersed power source in combination with a commercial power source by a control means being provided which means is connected to the dispersed power source and the plurality of the home electric appliances via a network and which means performs ON/OFF control of each of the home electric appliances; adjustment means being provided which means are respectively installed in the plurality of the home electric appliances; the control means transmitting a delay time of the dispersed power source that occurs at a change of a load of the dispersed power source; and the adjustment means performing ON/OFF control of the plurality of the home electric appliances in response to the delay time.

At this time even if the selective ON/OFF control of the plurality of the home electric appliances by the control means is designed to be given according to priorities set in advance, the object is achieved; and furthermore, at this time even if the control means is designed to be equipped with an input means and the priorities are designed to be changeable by the input means, the object is achieved.

In addition, at this time even if the control means is designed to change the priorities according to at least one of time and season, the object is achieved; and furthermore, at this time even if the dispersed power source is designed to be equipped with a plurality of power generation means and an operation number of these power generation means is designed to be controlled depending on power generation electric power demanded for the dispersed power source, the object is achieved.

At this time the dispersed power source may be configured of a cogeneration facility.

### BRIEF DESCRIPTION OF THE DRAWINGS

FIG. 1 is a block diagram showing one of embodiments of an in-home dispersed power source system related to the present invention.

FIG. 2 is a configuration showing one example of a dispersed power source in the present invention.

FIG. 3 is a characteristic drawing illustrating first operation according to a first embodiment of the present invention.

FIG. 4 is a characteristic drawing illustrating second operation according to the first embodiment of the present invention.

FIG. 5 is a characteristic drawing illustrating third operation according to the first embodiment of the present invention.

FIG. 6 is a characteristic drawing illustrating operation according to a second embodiment of the present invention.

FIG. 7 is a characteristic drawing illustrating operation according to a third embodiment of the present invention.

FIG. 8 is a characteristic drawing showing a relationship of an output for time of a dispersed power source in a fourth embodiment of the present invention.

FIG. 9 is a characteristic drawing showing a relationship between an output and time of the dispersed power source in the fourth embodiment of the present invention.

### DESCRIPTION OF THE PREFERRED EMBODIMENTS

Hereinafter, an in-home dispersed power source system will be described in detail according to the embodiments of the present invention shown in the drawings.

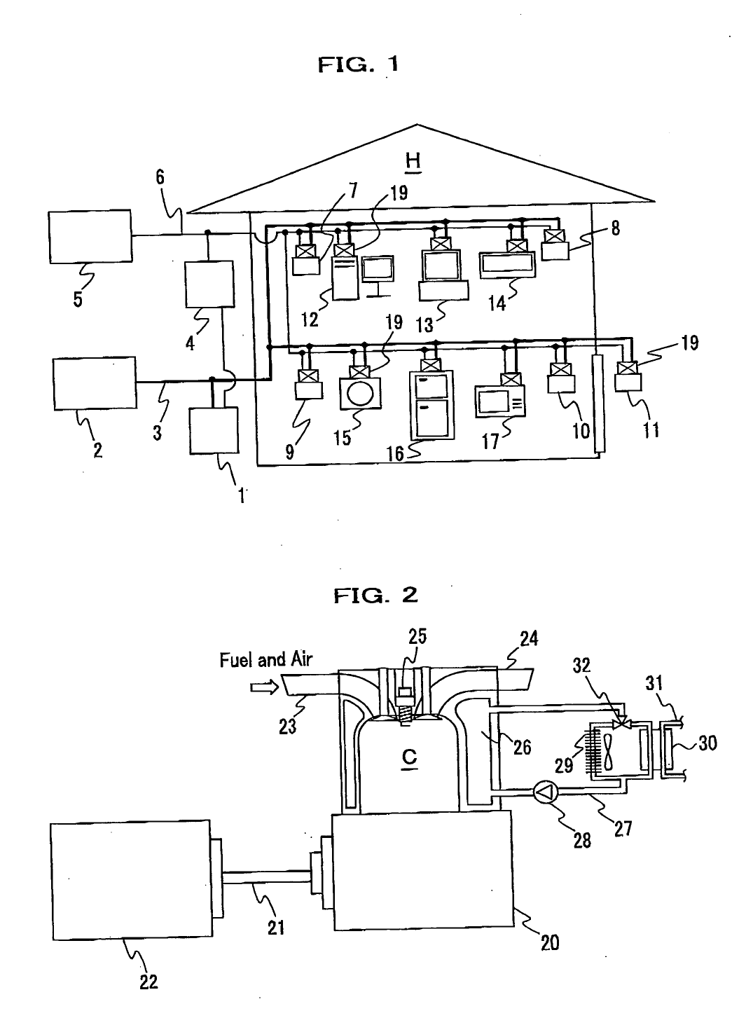

FIG. 1 is one of the embodiments of the present invention: this is designed to provide a dispersed power source 1 at a house H of certain home, and using this electric power and another electric power supplied from a commercial power source 2 in combination, electric power is designed to be supplied to each home electric appliance within the house H through an electric wiring 3.

And then contract electric power contracted with a power company is assumed, for example, to be 1000 W. Meanwhile, normally the contract with the power company and the like is for a maximum current, and accordingly, in this case assuming a power factor to be one in a voltage of 100 V, a contract current becomes 10 A.

Each of the home electric appliances is designed to be connected to a control device 4 and also to an information communications agency 5 through a communications line 6, and sending/receiving of information to/from external communications tools is designed to be able to be performed through a communications line of the information communications agency 5.

Thus each of the home electric appliances is networked, a user can of course perform ON/OFF operation directly or by a remocon appended on each of the home electric appliances, it is also ON/OFF controlled by the control device 4, and furthermore, is designed so that the ON/OFF operation can be performed from external communications tools, for example, a cellular phone and the like.

Although at this time the control device 4 is not shown, it is configured of a Central Processing Unit (CPU) that runs processes according to set programs, a read only memory (ROM) memorizing a control program and data, a memory unit recording consumption electric power and a priority of each of the home electric appliances and user's information, a timer, an interface communicating with each of the home electric appliances, and the like.

And to the electric wiring 3 and the communications line 6 as home electric appliances are connected room lightings 7 to 10, an entrance lighting 11, a personal computer 12, a television 13, an aircon 14, a washing machine 15, a refrigerator 16, and a microwave 17, respectively, through adjustment devices 19.

Here, the adjustment devices 19 are equipped with an interface for performing data communications with the control device 4 and an output adjustment mechanism for adjusting electric power supplied to the home electric appliances by signals from the control device 4.

In each of the home electric appliances such as the room lightings 7 to 10, a priority is set in advance, the priority of each of the home electric appliances is memorized in the control device 4, and the device 4 can select a home electric appliance to supply electric power depending on its priority.

In addition, the control device 4 is also connected to the dispersed power source 1 through the communications line 6 and always monitors an operation state of the dispersed power source 1.

FIG. 2 is one example of the dispersed power source 1: the power source 1 is configured of a cogeneration facility generating electric power and heat; and so, as shown in the drawing, as a motor is used a gas engine 20 whose fuel is a city gas.

And to a drive shaft 21 of the gas engine 20 is connected a generator 22 that has, for example, a capacity of 1000 W, and thus an electric power of 1000 W is designed to be able to be supplied at maximum. Therefore, the electric wiring 3 is connected to the generator 22 and thus generated electric power is designed to be supplied to each of the home electric appliances.

Meanwhile, the motor of the dispersed power source 1 is not restricted to the gas engine 20, even a diesel engine and a mixed-air compression-ignition type of engine are available, and furthermore, even a gas turbine is available.

In addition, as the dispersed power source 1 a fuel cell may be used, and since at this time the fuel cell also generates heat based upon power generation, it similarly functions as a cogeneration facility.

The gas engine 20 shown in FIG. 2 is configured of a suction pipe 23 in which air and fuel are supplied, an exhaust pipe 24 for exhausting an exhaust gas, and a cylinder C equipped with an ignition plug 25, wherein a cooling water passage 26 for absorbing heat is provided in the cylinder C and cooling water heated by exhausted heat is designed to circulate in a piping 27 by a pump 28.

In the piping 27 are parallelly provided a radiator 29 and a heat exchanger 30, and the cooling water is designed to flow through a way selected by a change valve 32. And when the radiator 29 is selected, heat is radiated is there.

On the other hand, when the heat exchanger 30 is selected, hot water that has exchanged heat with the cooling water is designed to be supplied to a hot water reservoir not shown through a hot water supply piping 31 and to be reserved there, thereby being utilized for a hot water supply, heating, cooling, and the like.

Returning to FIG. 1, all of the system is designed to be controlled by the control device 4. First, a partial operation output of the dispersed power source 1 has been set in incremental steps, has been memorized in the ROM of the control device 4, and thus is selected by the CPU, depending on a load demanded from the home electric appliances.

Here, in the embodiment respective operation conditions of 20%, 40%, 60%, 80%, and 100% for a maximum output are memorized in the ROM, and since at this time the dispersed power source 1 of 1000 W is used as described above, operation of each output of 200 W, 400 W, 600 W, 800 W, and 1000 W is possible, and including the electric power supplied from the power company, an electric power demand of 1200 W, 1400 W, 1600 W, 1800 Wₙ and 2000 W can be met.

And a nearest one that is not more than a demand load from the home electric appliances is selected out of these operation conditions by the ROM. For example, when 1700 W is demanded in all home electric appliances, 1600 W is selected; when 1900 W is demanded, its operation condition becomes 1800 W. However, when the demand load is less than 1200 W, the dispersed power source 1 is stopped.

Next, describing operation of the embodiment, when the dispersed power source 1 starts the operation, a delay occurs by time when demanded electric power is output, whereby the output electric power of the dispersed power source 1 runs short for the electric power demanded by the home electric appliances during this time.

In addition, also when the operation condition is changed as a result of a load change, the delay occurs by time when an output reaches a target value, whereby an electric power shortage occurs during this time.

To be more precisely described, for example, an internal combustion engine such as a gas engine as well known cannot start by itself, so it is requested to be given torque by a starter from outside and to be forcibly rotated before the torque occurs by itself, and accordingly, it takes at least several seconds before power generation is obtained.

This is same in a case of the gas turbine, and none the less, the fuel cell has the delay before prescribed electric power occurs although a reason is different. Particularly, in a case of the fuel cell since an electromotive force is obtained by a chemical change of a fuel, electric power cannot be obtained before the chemical change becomes a steady state.

Furthermore, since a temperature of the fuel cell must have reached a prescribed value, the delay further increases, and in addition, is also subject to the temperature of the feel cell in activation and an atmospheric temperature.

Consequently, in the embodiment an operation state of each of the home electric appliances is selected, depending on the priority set for each; and thus while the output electric power of the dispersed power source 1 rises, consumption electric power is controlled by the control device 4 so as to stay within power generation electric power.

In other words, when a certain home electric appliance is made ON and this results in a situation that needs electric power by the dispersed power source 1, the control device 4 controls so that another home electric appliance that is lower in priority than the former appliance is forcibly made OFF while the electric power by the dispersed power source 1 rises even if the latter appliance has been made ON.

The priority at this time is set high for still another home electric appliance, for example, such as the microwave 17 whose operation time is short and that is wanted to directly operate; the priority is set low for other home electric appliances such as the aircon 14 and the entrance lighting 11 that have not much problem even if they stop for a short time.

Although the priority is set in advance by a system manufacturer, and after recorded in a memory unit of the control device 4, is used for controlling, then it is also designed to be automatically changeable further according to time and season.

In addition, the priority may also be designed to be changeable depending on a user's liking, and in this case, information with respect to the priority is input in the control device 4 through its input device from a user or a service man entrusted by the user, thereby being recorded in the memory unit of the control device 4.

In the embodiment assuming that there are six grades of priorities, they become higher from priority 1 to priority 5 in this order and the highest priority 6 is set so that an electric power supply is not shut off as far as it is instructed to be ON.

Next, for operation of the embodiment, assuming several situations within home, the operation in each situation will be described.

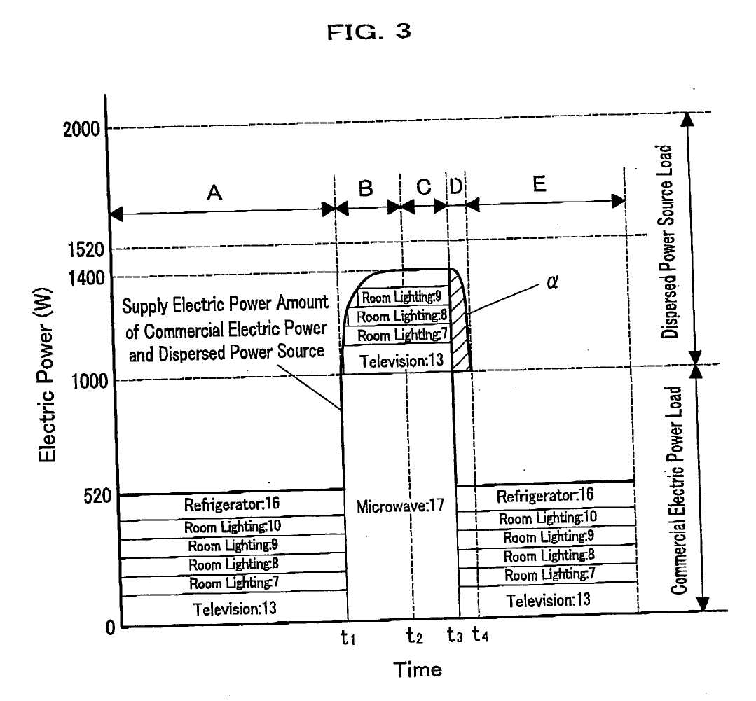

First, FIG. 3 is a first operation example: an operation example in which a home situation of a comparatively light time zone such as daytime is assumed as one example; and in which the priorities are set as follows:

[Priorities in First Operation Example]

Priority 1: the entrance lighting 11 (consumption electric power, 60 W)
Priority 2: the aircon 14 (consumption electric power, 900 W) the refrigerator 16 (consumption electric power, 80 W)
Priority 3: the room lighting 7 (consumption electric power, 70 W); the room lighting 8 (consumption electric power, 70 W); and the washing machine 15 (consumption electric power, 500 W)
Priority 4; the room lighting 9 (consumption electric power, 70 W); the room lighting 10 (consumption electric power, 70 W); and the television 13 (consumption electric power, 160 W)
Priority 5: the personal computer 12 (consumption electric power, 200 W); and the microwave (consumption electric power, 1000 W)
Priority 6: no relevant item

And in a time zone A not reaching a time t1, the room lightings 7 to 10, the television 13, and the refrigerator 16 are assumed to be ON.

If so, consumption electric power amounts to 520 W at this time, and accordingly, since in this case the consumption electric power is not more than the contract electric power contracted with the power company, 1000 W, so it is all covered by the electric power supplied from the commercial power source 2.

Next, assume that a user makes the microwave 17 ON at the time t1. If so, an electric power of 1000 W is added, and therefore, demand electric power from the home electric appliances becomes 1520 W. As a result, the control device 4 decides an output of the dispersed power source 1 to be 40% according to the above operation condition.

Consequently, data for deciding the operation condition of the 40% output is sent to the dispersed power source 1 through the communications line 6 together with an instruction of an operation start, and thus the operation is started, but even if the dispersed power source 1 starts the operation at the time t1, there is a delay for the output to reach 40%, whereby a state in which an actual output is lower than a target value results in occurring in a time zone B.

Therefore, the control device 4 monitors a load of the dispersed power source 1 and controls so that the home electric appliances whose priorities are higher are preferentially made ON. At this time the highest home electric appliance in priority is the microwave 17, and accordingly, the power sources of the home electric appliances other than the microwave 17 are firstly made OFF once at the time t1 by the control device 4.

And as the output of the dispersed power source 1 rises, the control device 4 makes the power source of the television 13 ON depending on its priority, and next, controls so as to make the room lightings 7 to 8, and to 9 ON in this order.

At this time in the time zone B from the time t1 to a time t2 and a time zone C from the time t2 to a time t3, the demand electric power from the home electric appliances is 1520 W, and whereas, supply electric power is made 1400 W, whereby the lighting 10 and the refrigerator 16 whose priorities are lower are held OFF as they are.

Then, since when the microwave 17 is made OFF at the time t3, the demand electric power lowers to 520 W and a state that can be covered only by the commercial power source 2 is resumed, thus the operation of the dispersed power source 1 at the time t3 is stopped, operation becomes to be performed by the electric power supplied from the commercial power source 27 and at the same time the power sources of the lighting 10 and refrigerator 16 are made ON, thereby an original state being resumed.

But the operation of the dispersed power source 1 at this time produces a delay by a stoppage from time when a stoppage signal is issued at the time t3 from the control device 4, and a time zone D becomes an electric power supply excess state, whereby an excess electric power a occurs. However, in this case the excess electric power α is controlled so as to be supplied to the commercial power source 2 and is sold to the power company. Here, the excess electric power a can also be used for making ice and reserving hot water at the house H.

Then, when it becomes a time zone E from the time zone D at a time t4, an electric power supply state is resumed to the same state as in the first time zone A, and as shown, the state becomes one in which the room lightings 7 to 10, the television 13, and the refrigerator 16 are On.

Accordingly, although in this case the television and the lightings may instantaneously flicker, without having a possibility of it being noticed with also a help of a comparatively light time zone, a merit by introducing the dispersed power source system can be enjoyed with holding amenities.

Incidentally, although in the first operation described above the priority of the microwave 17 is set higher than those of the room lightings 7 to 10, it is requested to change the priorities according to time since it is badly off for room lightings to be OFF at night. In addition, there are some home electric appliances that a user does not want to make OFF, and therefore, as described above these information is designed to be able to change settings by being input in the control device 4.

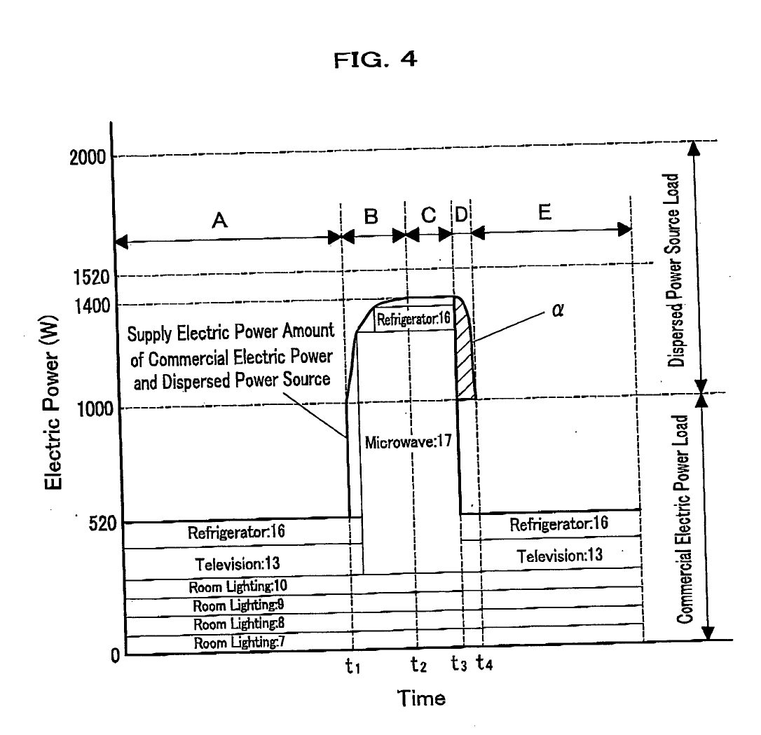

Consequently, next, as a second operation of the embodiment, a case in is which the priority of the room lightings 7 to 10 are made 6 will be described according to FIG. 4. Namely, in an operation example of FIG. 4, the priorities as below are assumed to be set.

[Priories in Second Operation Example]

Priority 1: the entrance lighting 11 (consumption electric power, 60 W)
Priority 2; the aircon 14 (consumption electric power, 900 W); and the refrigerator 16 (consumption electric power, 80 W)
Priority 3: the washing machine 15 (consumption electric power, 500 W)
Priority 4: the television 13 (consumption electric power, 160 W)
Priority 5: the personal computer 12 (consumption electric power, 200 W); and the microwave (consumption electric power, 1000 W)
Priority 6: the room lighting 7 (consumption electric power, 70 W); the room lighting 8 (consumption electric power, 70 W); the room lighting 9 (consumption electric power, 70 W); and the room lighting 10 (consumption electric power, 70 W)

Here, first, the case of FIG. 4 is also same as that of the first operation example of FIG. 3 in the time zone A, and second, it is also same as in the first operation example that the switch of the microwave 17 is made ON at the time t1 when the time zone A changes to the time zone B and the dispersed power source 1 is activated and entered in the time zone B.

Furthermore, it is also same in the operation example of FIG. 4 that the delay occurs by time when the power generation electric power of the dispersed power source 1 reaches a target value, whereby electric power necessary for starting the operation of the microwave 17 cannot be obtained.

In this example since the priority of the room lightings 7 to 10 is 6 and they cannot anyway be made OFF, the microwave 17 is not actually made on immediately notwithstanding it being made ON by a user at this time even if its priority is high, and thus the microwave 17 waits as is OFF. Accordingly, the power sources of the television 13 and the refrigerator 16 are held ON.

And after the time t1 the output of the dispersed power source 1 keeps on rising in the time zone B, and when it is judged by the control device 4 that the electric power necessary for the operation of the microwave 17 is reached, here at the first time the power sources of the television 13 and the refrigerator 16 are controlled to be OFF, and at the same time the microwave 17 is made ON.

Then, although when the output of the dispersed power source 1 rises and excess electric power occurs, the television 13 that is high in priority ought to be made ON in itself, at this time the output of the dispersed power source 1 is set 40% from its operation condition described above.

Therefore, if the television 13 is made ON, total electric power results in exceeding 1400 W. Consequently, the refrigerator 16 whose priority is next high is controlled so as to be made ON.

And a time zone moves from the time zone B to the time zone C at the time t2, and furthermore, in a region where time lapses from the time zones D to E, an operation example is same as the first one described in FIG. 3, so its description is omitted.

Accordingly, although in this case an image of the television may instantaneously flicker, without having the possibility of the lightings going out notwithstanding darkness, the merit by introducing the dispersed power source system can be enjoyed with holding the amenities.

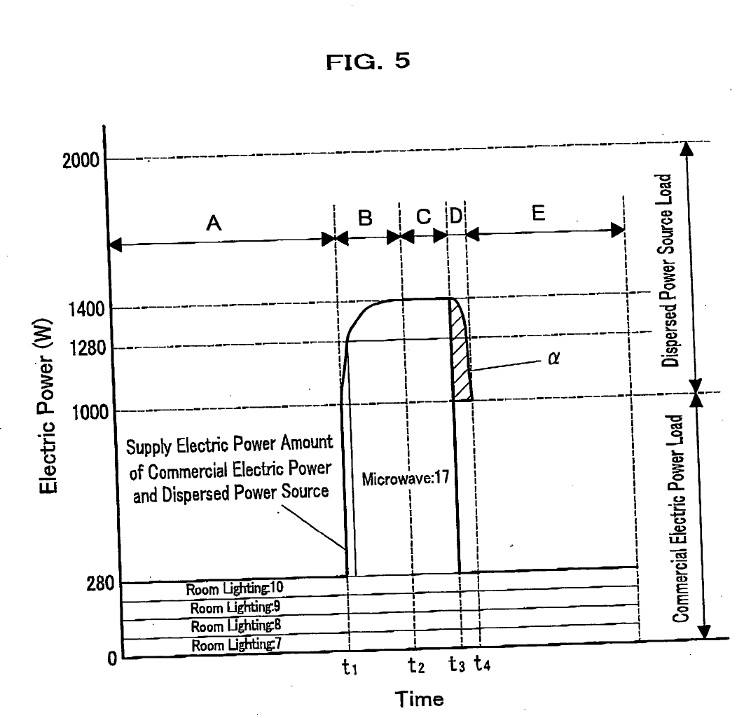

Next, as a third operation example of the embodiment, a case, in which the priority of the lightings 7 to 10 is 6 same as in the second operation example of FIG. 4 and furthermore the priority of the microwave 17 is also 6, will be described, referring to FIG. 5.

In the case of the third operation example of FIG. 5, first, the room lightings 7 to 10 are assumed to be ON, as shown, in the time zone A before the time t1. If so, the consumption electric power amounts to 280 W at this time, so it is all covered by the electric power supplied from the commercial power source 2.

Here, assume that a user makes the microwave 17 ON at the time t1. If so, the electric power demanded from all of the home electric appliances amounts to 1280 W. Consequently, from the above operation condition, an output load of the dispersed power source 1 in this case ought to be decided to be 20% in itself.

But in this case the room lightings 7 to 10 are the home electric appliances with the priority 6, so any cannot be made OFF. Therefore, alternatively the operation condition of the dispersed power source 1 is decided to be 40%, one grade higher condition, and operation condition data and an operation start instruction corresponding to this are sent to the dispersed power source 1 through the communications line 6.

But even then the delay occurs by time when the output of the dispersed power source 1 reaches 40%, and the power source of the microwave 17 cannot be immediately made ON, thereby another delay occurring by time when the power source of the microwave 17 becomes to be made ON. However, in this case the delays can be suppressed less by raising the operation condition of the dispersed power source 1 by one grade.

After the output of the dispersed power source 1 reaches 280 W in the time zone B, the supply electric power becomes an excess state since it amounts to 1400 W, and whereas, the demand electric power is 1280 W. However, in this case the excess electric power can be effectively utilized by being sold to the power company and being used for making ice and reserving hot water.

Thus, when the microwave 17 is made OFF at the time t3 and a time zone moves to the time zone D, the demand electric power in this region lowers to 280 W, thus the control device 4 makes the operation of the dispersed power source 1 stop and resumes a state by only the electric power supplied from the commercial power source 2.

But still another delay occurs by time when the dispersed power source 1 is actually stopped from time when a stoppage signal is issued from the control device 4, whereby the excess electric power a also occurs here. However, also in this case the excess electric power can be effectively utilized by being sold to the power company and being used for making ice and reserving hot water.

Then a time zone moves to the time zone E and this is same as in the first operation example described in FIG. 3, so its description is omitted. Also in this case although an image of the television 13 may flicker, without having the possibility of the lightings going out notwithstanding darkness, the merit by introducing the dispersed power source system can be enjoyed with holding the amenities.

Incidentally, in the embodiment thus described the dispersed power source 1 is one and is partially operated including a maximum rated output, whereby the electric power output by the dispersed power source 1 is designed to be controlled in incremental steps.

But alternatively, the present invention can use a plurality of dispersed power sources and perform controlling of an electric power output in incremental steps by partial load operation, including a maximum rated output with changing an operation number of the dispersed power sources. Consequently, such the case will be described as below as a second embodiment of the invention.

Also in the second embodiment an overall configuration seen as a block diagram is same as that of the first embodiment shown in FIG. 1, and a different point exists not in a point that the dispersed power source 1 is one internal combustion engine drive generator; but in another point that the dispersed power source 1 plurally/parallelly uses internal combustion engine drive generators with a smaller capacity than that of the above generator, or an internal combustion engine drive generator whose system is to drive one generator by coupling a plurality of internal combustion engines with a smaller capacity.

And a merit of the second embodiment exists in a point that each internal combustion engine drive generator can be operated in a most efficient operation condition since change control of an electric power output of the dispersed power source 1 can be controlled according to an increase/decrease of a number of the internal combustion engine drive generators.

The second embodiment described here, as an example, uses ten cogeneration systems in combination of motors and generators with a rated electric power output of 100 W and is designed to be able to control an output from 100 W, 200 W, . . . , to 1000 W in incremental steps by controlling an operation number of the systems from 1, 2, . . . , to 10; to generate an output of 1000 W at maximum; and to furthermore make combination with the commercial power source 2 with a contract electric power of 1000 W, whereby a maximum electric power of 2000 W is designed to be able to be supplied at maximum same as in the first embodiment.

Meanwhile, as an operation number of the internal combustion engine drive generators configuring the dispersed power source 1, a nearest number is selected by the CPU of the control device 4, depending on an electric power load demanded from each of the home electric appliances and on a condition that electric power by the nearest number is not more than the electric power load demanded case by case.

For example, when an electric power of 1650 W is demanded from the home electric appliances, six internal combustion engine generators are operated; when a demand electric power load is less than 1100 W, its number becomes zero. And a control program and data necessary therefor are stored in the ROM of the control device 4 in advance.

Next, describing ON/OFF control of the home electric appliances according to the second embodiment, first as described above when the operation number of the internal combustion engine generators of the dispersed power source 1 is made to become not more than an electric power load demanded from the home electric appliances, some output electric power of the dispersed power source 1 becomes lower than the demand electric power of the home electric appliances.

In addition, when the electric power load from the home electric appliances increases, and the dispersed power source 1 is activated or the operation number is increased, a time delay occurs by time when output electric power reaches a target value, and an electric power shortage occurs during this time. Consequently, the second embodiment is designed so that home electric appliances to be made ON are selected by the control device 4, depending on the priorities by which consumption electric power becomes not more than power generation electric power during this time.

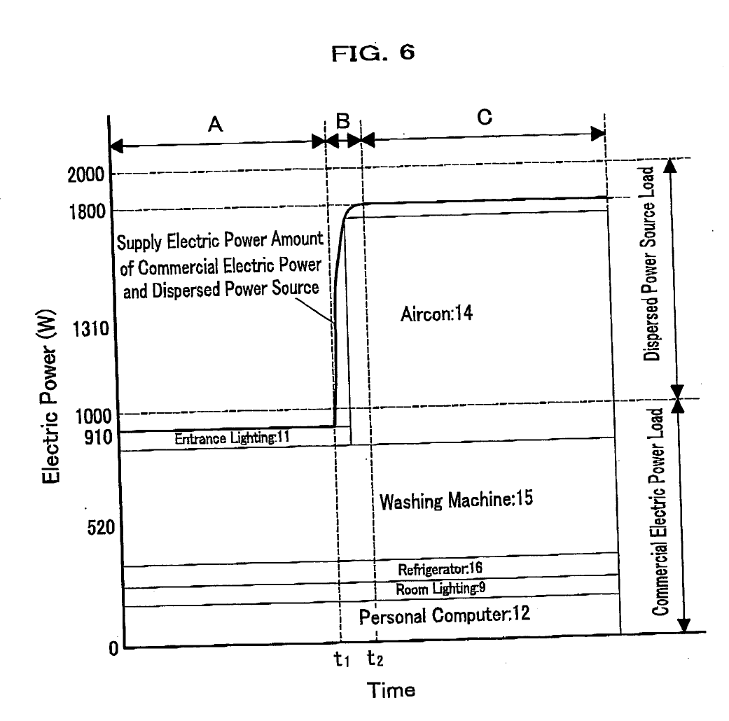

Here, an operation example, in which the priority and consumption electric power of each of the home electric appliances are assumed to be same as those of the first operation example described in FIG. 3, is described below referring to FIG. 6.

In FIG. 6, first in the region of the time zone A the room lighting 9, the entrance lighting 11, the personal computer 12, the washing machine 15, and the refrigerator 16 operate, and accordingly, the consumption electric power amounts to 910 W and it is not more than the contract electric power, thereby being all covered by the commercial power source 2.

And now if a user activates the aircon 14 at the time t1, the demand electric power from the home electric appliances amounts to 1810 W. Consequently, the control device 4 decides the operation number of the internal combustion engine generators of the dispersed power source 1 to be eight according to the operation condition described above, and makes operation condition data and an operation start instruction sent to the dispersed power source 1 through the communications line 6.

Although at this time a delay occurs by time when the output of the dispersed power source 1 reaches 800 W, and a region in which an actual output is lower than a target output occurs as shown in the time zone B, the entrance lighting 11 is lowest in priority and the aircon 14 is higher than the entrance lighting 11 in priority. Therefore, the entrance lighting 11 is made OFF at a timing when the supply electric power by the dispersed power source 1 reaches 1750 W, here the power source of the aircon 14 is made ON, hereby its operation being started, and this state is also made to be held in the region of the time zone C.

Accordingly, also in this case the merit by introducing the dispersed power source system can be enjoyed with holding the amenities.

Next, describing a third embodiment of the present invention, this is different in a method for deciding the operation condition of the dispersed power source 1, and here, the operation condition of nearest output electric power not less than an electric power load demanded from the home electric appliances is designed to be selected.

Accordingly, also in the third embodiment an overall configuration and the dispersed power source 1 are same as those of the first embodiment in FIG. 1, and a different point exists in a point that when an electric power of, for example, 1700 W is demanded from the home electric appliances, an operation condition of an output of 1800 W is set in the dispersed power source 1; when an electric power of 1900 W is demanded, that of an output of 2000 W is set; and when the demand electric power load is not more than 1000 W, the dispersed power source 1 is stopped. And a control program and data necessary therefor are stored in the ROM of the control device 4 in advance.

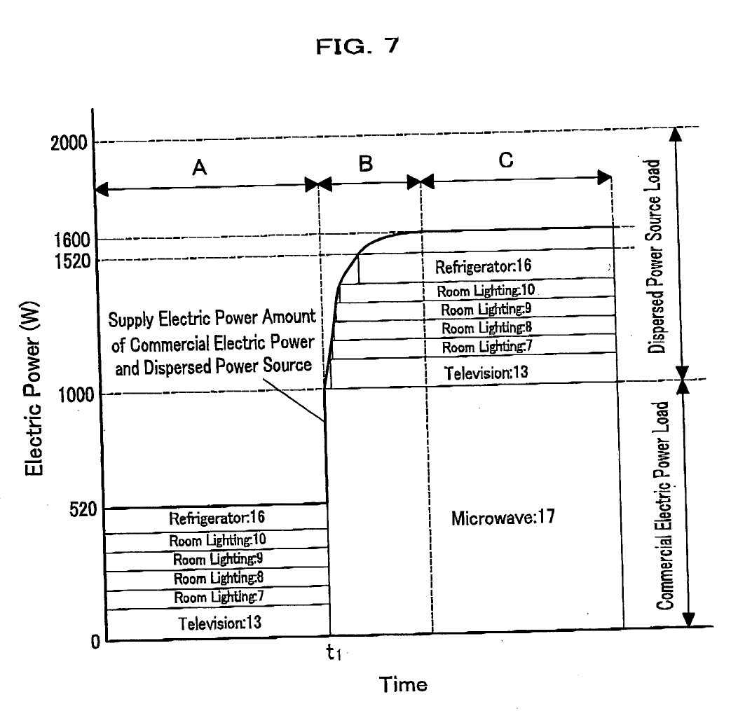

Next, describing an operation example of the third embodiment referring to FIG. 7, first in the region of the time zone A the room lightings 7 to 10, the television 13, and the refrigerator 16 operate, and accordingly, the consumption electric power amounts to 520 W and it is not more than the contract electric power, thereby being all covered by the commercial power source 2.

Now since if a user activates the microwave 17 at the time t1, the demand electric power from the home electric appliances amounts to 1520 W, the control device 4 decides the output of the dispersed power source 1 to be 60% according to the operation condition described above, and sends operation condition data and an operation start instruction to the dispersed power source 1 through the communications line 6.

As a result, although the output of the dispersed power source 1 is set 600 W and thus amounts to 1600 W that is more than 1520 W totally demanded from the home electric appliances, a delay occurs by time when the output of the dispersed power source 1 reaches 60%, and as shown in the time zone B, a region in which an actual output is lower than a target output results in occurring.

But the output of the dispersed power source 1 is sequentially monitored by the control device 4, accordingly as shown in the drawing, home electric appliances higher ill priority are controlled so as to preferentially operate, thus all home electric appliances become ON for the first time at a timing when the output reaches 1520 W, and this state is also held in the region of the time zone C.

Accordingly, this case can also enjoy the merit by introducing the dispersed power source system with holding the amenities.

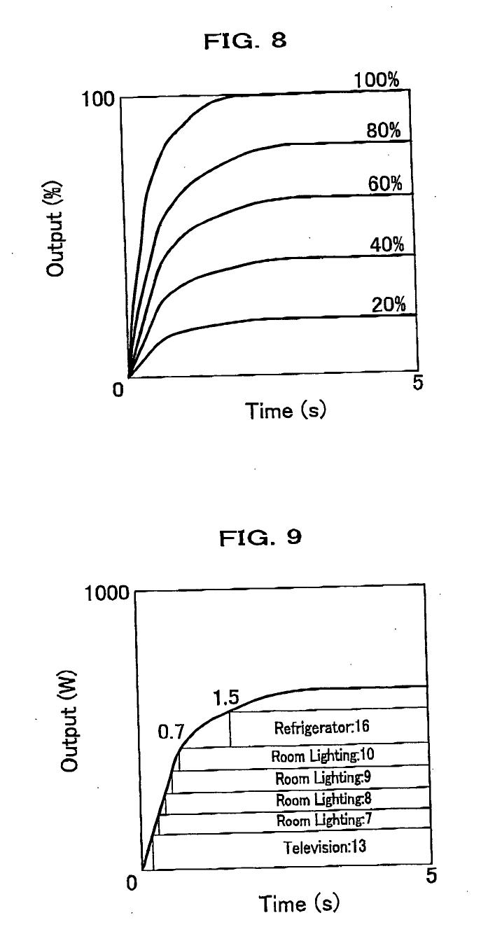

Next, describing a fourth embodiment of the present invention, this is characterized by following points: a point of memorizing output changes from activation of the dispersed power source 1 as a MAP shown in FIG. 8; another point of obtaining an electric power suppliable time for the demand electric power of each of the home electric appliances by the control device 4, from the operation condition of the dispersed power source 1, and sending the information to the each adjustment device 19; and still another point of the operation condition of the dispersed power source 1 being selected as a nearest condition not less than a load demanded from each of the home electric appliances.

Accordingly, also in the fourth embodiment an overall configuration and the dispersed power source 1 are same as those of the first embodiment in FIG. 1, and an only different point is that a program matching the above points is stored in the ROM of the control device 4.

Consequently, next, an operation example of the fourth embodiment is described referring to FIG. 7, same as in the third embodiment described above.

First, assume that the microwave 17 is similarly made ON at the time t1. If so, an electric power load demanded from all home electric appliances amounts to 1520 W at this timing, and therefore, a load of the dispersed power source 1 is set 60%.

At this time in the operation of the fourth embodiment, output changes for time of the dispersed power source 1 are obtained by the MAP of FIG. 8; thus electric power is supplied to the home electric appliances depending on the priorities; furthermore, in this case the home electric appliances to which the electric power should be supplied are not selected by the control device 4; and in this case it is designed so that: the delay time of the dispersed power source 1 is obtained from a MAP shown in FIG. 9; an activation time of each of the home electric appliances decided depending on the MAP is sent to the each adjustment device 19; and at a timing when the activation time is reached, each of the home electric appliances is individually activated.

Accordingly, in the operation example of the fourth embodiment, from characteristics of the dispersed power source 1 in an output of 60% shown in FIG. 9, for example, the room lighting 10 is made ON after 0.7 second since the microwave 17 becomes ON, the refrigerator 16 is made ON similarly after 1.5 seconds, and as a result, the merit by introducing the dispersed power source system can be enjoyed with holding the amenities.

Thus, although the embodiments of the present invention are described, the invention is not limited to such the embodiments and various variations are available without departing from the spirit and scope of the invention.

1. An in-home dispersed power source system that is designed to supply electric power to a plurality of home electric appliances with using a dispersed power source in combination with a commercial power source, the system comprising:
a control means that is connected to said dispersed power source and said plurality of the home electric appliances via a network, and that performs ON/OFF control of each of the home electric appliances,
wherein said control means makes each of the home electric appliances follow a response delay of power generation operation of said dispersed power source by selective ON/OFF control of said plurality of the home electric appliances.

2. An in-home dispersed power source system according to claim 1, wherein selective ON/OFF control of said plurality of home electric appliances by said control means is given in accordance with a priority set in each of the home electric appliances in advance.

3. An in-home dispersed power source system according to claim 2, wherein said control means comprises an input means and said priority is configured so as to be changeable by said input means.

4. An in-home dispersed power source system according to claim 2, wherein said control means is configured so as to change said priority by at least one of time and season.

5. An in-home dispersed power source system according to claim 1, wherein said dispersed power source comprises a plurality of power generation means, and wherein an operation number of the power generation means is controlled, depending on power generation electric power demanded for sad dispersed power source.

6. An in-home dispersed power source system according to claim 1, wherein said dispersed power source is configured of a cogeneration facility.

7. An in-home dispersed power source system that is designed to supply electric power to a plurality of hose electric appliances with using a dispersed power source in combination with a commercial power source, the system comprising:
a control means that is connected to said dispersed power source and said plurality of the home electric appliances via a network, and performs ON/OFF control of each of the home electric appliances; and
adjustment means that are respectively provided for said plurality of the home electric appliances,
wherein said control means transmits a delay time of said dispersed power source, which occurs when a load of said dispersed power source is changed, to said adjustment means, and
wherein said adjustment means make each of the home electric appliances follow a response delay of power generation operation of said dispersed power source by performing the ON/OFF control of each of the home electric appliances matching said delay time.

8. An in-home dispersed power source system according to claim 7, wherein said selective ON/OFF control of said plurality of home electric appliances by said control means is given in accordance with a priority set in each of the home electric appliances in advance.

9. An in-home dispersed power source system according to claim 8, wherein said control means comprises an input means and said priority is configured so as to be changeable by said input means.

10. An in-home dispersed power source system according to claim 8, wherein said control means is configured so as to change said priority by at least one of time and season.

11. An in-home dispersed power source system according to claim 7, wherein said dispersed power source comprises a plurality of power generation means, and wherein an operation number of the power generation means is controlled, depending on power generation electric power demanded for said dispersed power source.

12. An in-home dispersed power source system according to claim 7, wherein said dispersed power source is configured of a cogeneration facility.
